(19) United States
(12) Patent Application Publication
(10) Pub. No.: US 2023/0121270 A1
(43) Pub. Date: Apr. 20, 2023

(54) SYSTEMS AND METHODS FOR FACILITATING MOBILE PAYMENT TRANSACTIONS WITH A PLURALITY OF MERCHANTS

(71) Applicant: SIONIC MOBILE CORPORATION, Atlanta, GA (US)

(72) Inventor: Ronald Herman, Atlanta, GA (US)

(21) Appl. No.: 17/905,529

(22) PCT Filed: Mar. 2, 2021
(86) PCT No.: PCT/US21/20506

§ 371 Date: Sep. 2, 2022

Related U.S. Application Data
(60) Provisional application No. 62/983,859, filed on Mar. 2, 2020.

(51) Int. Cl. G06Q 20/32; G06Q 20/10; G06Q 20/38; G06Q 20/40; G06Q 30/0601; G06Q 30/0226

(52) U.S. Cl. CPC G06Q 20/3223; G06Q 20/3221; G06Q 20/10; G06Q 20/38215; G06Q 20/4014; G06Q 20/3224; G06Q 20/3255; G06Q 30/0611; G06Q 30/0226; G06Q 2220/00

(57) ABSTRACT

Systems and methods for facilitating mobile payment transactions with a plurality of vendors is described herein. An example method includes maintaining consumer information. The consumer information includes a plurality of respective account profiles associated with a plurality of consumers. The method also includes transmitting vendor content associated with a first vendor to a user's mobile computing device, and transmitting vendor content associated with a second vendor to the user's mobile computing device. The method further includes facilitating a plurality of mobile payment transactions with the user on behalf of the first and second vendors using a respective account profile associated with the user.

### CROSS-REFERENCE TO RELATED APPLICATIONS

This application claims the benefit of U.S. provisional patent application No. 62/983,859, filed on Mar. 2, 2020, and titled “SYSTEMS AND METHODS FOR FACILITATING MOBILE PAYMENT TRANSACTIONS WITH A PLURALITY OF MERCHANTS,” the disclosure of which is expressly incorporated herein by reference in its entirety.

### BACKGROUND

Mobile payments allow a user to conduct financial transactions via a portable electronic device such a cell phone or tablet computer. Several challenges exist which hamper the proliferation of mobile payments. Consumers are often required to create merchant-specific accounts and tie their payment method(s) to the account in order to complete a mobile payment. In many cases, the consumer must also download and register their account using a merchant-specified mobile app. As a result, the consumer is forced to have many accounts with basically the same information, including their payment information, on file with a large number of merchants. This exposes consumers to a degree of risk that could be avoided if there were a way to use the same account to perform mobile payments across a wide number of merchants. Tokenization removes some of the risk of storing payment methods with many merchants, but tokens themselves are not generally accepted across different merchants. This too, presents a challenge in offering a single account that can be readily used to checkout and pay at multiple merchants.

### SUMMARY

An example computer-implemented method for facilitating mobile payment transactions with a plurality of merchants is described herein. The method includes maintaining consumer information. The consumer information includes a plurality of respective account profiles associated with a plurality of consumers. The method also includes transmitting vendor content associated with a first vendor to a user's mobile computing device, and transmitting vendor content associated with a second vendor to the user's mobile computing device. The method further includes facilitating a plurality of mobile payment transactions with the user on behalf of the first and second vendors using a respective account profile associated with the user.

In some implementations, the step of facilitating the mobile payment transactions includes facilitating a first mobile payment transaction with the user on behalf of the first vendor using the respective account profile associated with the user and facilitating a second mobile payment transaction with the user on behalf of the second vendor using the respective account profile associated with the user. The first and second mobile payment transactions are separate transactions. Alternatively or additionally, the first vendor and the second vendor are merchant of record for the first and second mobile payment transactions, respectively. In some implementations, the step of facilitating the mobile payment transactions includes causing information from the respective account profile associated with the user to be transmitted to a respective payment processor associated with each of the first and second vendors. The payment processors for the first and second vendors can be the same or different payment processors. Optionally, the information from the respective account profile associated with the user includes a token. Optionally, the information from the respective account profile associated with the user includes a payment account number or an electronic money transfer request. Optionally, the information from the respective account profile associated with the user is encrypted. Additionally, the step of facilitating the mobile payment transactions further includes receiving a respective validation from the respective payment processors associated with the first and second vendors.

Alternatively or additionally, the vendor content is transmitted to the user's mobile computing device based on a location of the user's mobile computing device.

Alternatively or additionally, the vendor content is transmitted in a text message, rich communication services message, or instant message.

Alternatively or additionally, the vendor content is an offer for a good or service.

Alternatively or additionally, the vendor content is a menu.

Alternatively or additionally, the vendor content is configured for display on the user's mobile computing device. Optionally, the vendor content is tailored to a vendor's business processes or requirements.

Alternatively or additionally, the method further includes maintaining or accessing vendor information associated with a plurality of vendors. The vendors include, but are not limited to, a fuel retailer, an electric vehicle charging company, a convenience store, a grocery store, a restaurant, a parking company, or a hotel or motel.

Alternatively or additionally, each of the account profiles includes personal information, financial information, and payment method information.

Alternatively or additionally, each of the account profiles includes a token. Alternatively or additionally, the method further includes tokenizing at least a portion of each of the account profiles.

In some implementations, the step of facilitating the mobile payment transactions further includes receiving authorization for the mobile payment transactions from the user's mobile computing device. For example, authorization for the mobile payment transactions can be received from the user's mobile computing device via a microsite.

In some implementations, the step of facilitating the mobile payment transactions further includes transmitting the respective account profile associated with the user to a payment processor, and receiving validation from the payment processor. Optionally, the method further includes encrypting at least a portion of the respective account profile associated with the user before transmission to the payment processor.

Alternatively or additionally, the method further includes registering a user in a loyalty program associated with a vendor.

Another example computer-implemented method for facilitating mobile payment transactions with a plurality of merchants is described herein. The method includes maintaining consumer information. The consumer information includes a plurality of respective account profiles associated with a plurality of consumers. The method also includes transmitting vendor content associated with a first vendor to a user's Internet-connected device, and transmitting vendor content associated with a second vendor to the user's Internet-connected device. The method further includes facilitating a plurality of mobile payment transactions with the user on behalf of the first and second vendors using a respective account profile associated with the user.

In some implementations, the user's Internet-connected device is a television, a vehicle, or an appliance.

In some implementations, the step of facilitating the mobile payment transactions includes facilitating a first mobile payment transaction with the user on behalf of the first vendor using the respective account profile associated with the user and facilitating a second mobile payment transaction with the user on behalf of the second vendor using the respective account profile associated with the user. The first and second mobile payment transactions are separate transactions. Alternatively or additionally, the first vendor and the second vendor are merchant of record for the first and second mobile payment transactions, respectively. In some implementations, the step of facilitating the mobile payment transactions includes causing information from the respective account profile associated with the user to be transmitted to a respective payment processor associated with each of the first and second vendors. The payment processors for the first and second vendors can be the same or different payment processors. Optionally, the information from the respective account profile associated with the user includes a token. Optionally, the information from the respective account profile associated with the user includes a payment account number or an electronic money transfer request. Optionally, the information from the respective account profile associated with the user is encrypted. Additionally, the step of facilitating the mobile payment transactions further includes receiving a respective validation from the respective payment processors associated with the first and second vendors.

Alternatively or additionally, the vendor content is transmitted to the user's Internet-connected device based on a location of the user's Internet-connected device.

Alternatively or additionally, the vendor content is transmitted in a text message, rich communication services message, or instant message.

Alternatively or additionally, the vendor content is an offer for a good or service.

Alternatively or additionally, the vendor content is a menu.

Alternatively or additionally, the vendor content is configured for display on the user's Internet-connected device. Optionally, the vendor content is tailored to a vendor's business processes or requirements.

Alternatively or additionally, the method further includes maintaining or accessing vendor information associated with a plurality of vendors. The vendors include, but are not limited to, a fuel retailer, an electric vehicle charging company, a convenience store, a grocery store, a restaurant, a parking company, or a hotel or motel.

Alternatively or additionally, each of the account profiles includes personal information, financial information, and payment method information.

Alternatively or additionally, each of the account profiles includes a token. Alternatively or additionally, the method further includes tokenizing at least a portion of each of the account profiles.

In some implementations, the step of facilitating the mobile payment transactions further includes receiving authorization for the mobile payment transactions from the user's Internet-connected device. For example, authorization for the mobile payment transactions can be received from the user's Internet-connected device via a microsite.

In some implementations, the step of facilitating the mobile payment transactions further includes transmitting the respective account profile associated with the user to a payment processor, and receiving validation from the payment processor. Optionally, the method further includes encrypting at least a portion of the respective account profile associated with the user before transmission to the payment processor.

Alternatively or additionally, the method further includes registering a user in a loyalty program associated with a vendor.

An example system for facilitating mobile payment transactions with a plurality of merchants is described herein. The system includes a server comprising a processor and a memory in operable communication with the processor, the memory having computer-executable instructions stored thereon. The server is configured to maintain consumer information. The consumer information includes a plurality of respective account profiles associated with a plurality of consumers. The server is also configured to transmit vendor content associated with a first vendor to a user's device, and transmit vendor content associated with a second vendor to the user's device. The server is further configured to facilitate a plurality of mobile payment transactions with the user on behalf of the first and second vendors using a respective account profile associated with the user.

In some implementations, the system optionally includes the user's device, which is operably connected to the server over a network. Optionally, in some implementations, the user's device is a mobile computing device such as a smartphone. Optionally, in other implementations, the user's device is an Internet-connected device such as a television, a vehicle, or an appliance.

In some implementations, the step of facilitating the mobile payment transactions includes facilitating a first mobile payment transaction with the user on behalf of the first vendor using the respective account profile associated with the user and facilitating a second mobile payment transaction with the user on behalf of the second vendor using the respective account profile associated with the user. The first and second mobile payment transactions are separate transactions. Alternatively or additionally, the first vendor and the second vendor are merchant of record for the first and second mobile payment transactions, respectively. In some implementations, the step of facilitating the mobile payment transactions includes causing information from the respective account profile associated with the user to be transmitted to a respective payment processor associated with each of the first and second vendors. The payment processors for the first and second vendors can be the same or different payment processors. Optionally, the information from the respective account profile associated with the user includes a token. Optionally, the information from the respective account profile associated with the user includes a payment account number or an electronic money transfer request. Optionally, the information from the respective account profile associated with the user is encrypted. Additionally, the step of facilitating the mobile payment transactions further includes receiving a respective validation from the respective payment processors associated with the first and second vendors.

Alternatively or additionally, the vendor content is transmitted to the user's device based on a location of the user's device.

Alternatively or additionally, the vendor content is transmitted in a text message, rich communication services message, or instant message.

Alternatively or additionally, the vendor content is an offer for a good or service.

Alternatively or additionally, the vendor content is a menu.

Alternatively or additionally, the vendor content is configured for display on the user's device. Optionally, the vendor content is tailored to a vendor's business processes or requirements.

Alternatively or additionally, the server is further configured to maintain or access vendor information associated with a plurality of vendors. The vendors include, but are not limited to, a fuel retailer, an electric vehicle charging company, a convenience store, a grocery store, a restaurant, a parking company, or a hotel or motel.

Alternatively or additionally, each of the account profiles includes personal information, financial information, and payment method information.

Alternatively or additionally, each of the account profiles includes a token. Alternatively or additionally, the server is further configured to tokenize at least a portion of each of the account profiles.

In some implementations, the step of facilitating the mobile payment transactions further includes receiving authorization for the mobile payment transactions from the user's device. For example, authorization for the mobile payment transactions can be received from the user's device via a microsite.

In some implementations, the step of facilitating the mobile payment transactions further includes transmitting the respective account profile associated with the user to a payment processor, and receiving validation from the payment processor. Optionally, the server is further configured to encrypt at least a portion of the respective account profile associated with the user before transmission to the payment processor.

Alternatively or additionally, the server is further configured to register a user in a loyalty program associated with a vendor.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a diagram illustrating an example microsite according to implementations described herein.

FIG. 2 is a flow diagram illustrating example operations for facilitating mobile payment transactions with a plurality of merchants according to implementations described herein.

FIG. 3 is an example computing device.

FIGS. 4A-4D illustrate an example process for creating an account at a microsite using a mobile computing device according to implementations described herein. FIG. 4A illustrates account creation at the microsite using a user's mobile number. FIG. 4B illustrates collection of account information at the microsite. FIG. 4C illustrates collection of financial information such as a credit card number and/or digital wallet at the microsite. FIG. 4D illustrates collection of payment method information at the microsite.

FIG. 5 illustrates an example message related to a fuel/gas retailer as displayed on a user's mobile computing device according to an implementation described herein.

FIG. 6A illustrates an example deep link provided in third-party apps related to fuel/gas retailers as displayed on a user's mobile computing device according to an implementation described herein. FIG. 6B illustrates another example deep link provided in third-party apps related to fuel/gas retailers as displayed on a user's mobile computing device according to an implementation described herein.

FIGS. 7A-7C illustrate an example process for completing a mobile payment transaction at a fuel/gas retailer according to an implementation described herein. FIG. 7A illustrates the presentation a vendor's offer to a user. FIG. 7B illustrates the user has selected “Pay for Fuel” and is presented with an option to select a pump. FIG. 7C illustrates that fueling is authorized and presents the user with instructions for completing the transaction.

FIG. 8A illustrates an example message related to a restaurant as displayed on a user's mobile computing device according to an implementation described herein. FIG. 8B illustrates an example deep link provided in a third-party app related to the restaurant as displayed on the user's mobile computing device in response to the user opening the message shown in FIG. 8A.

FIGS. 9A-9D illustrate an example process for completing a mobile payment transaction with a restaurant according to an implementation described herein. FIG. 9A illustrates the presentation of a vendor's offer to a user. FIG. 9B illustrates presentation of the menu options to the user. FIG. 9C illustrates the user's selection of menu items and the presentation of instructions for completing the transaction. FIG. 9D illustrates presentation of the user's confirmation of purchase.

FIG. 10A illustrates an example operating environment according to implementations described herein. FIG. 10B is a flow diagram illustrating example operations for facilitating mobile payment transactions with a plurality of merchants within the operating environment of FIG. 10A.

FIGS. 11A-11C illustrate example operations for adding a credit card to a user's account profile according to implementations described herein.

FIGS. 12A-12C illustrate example operations for completing a mobile payment transaction with credit card information according to implementations described herein.

FIGS. 13A-13D illustrate example operations for completing a mobile payment transaction with a network token according to implementations described herein.

FIGS. 14A and 14B illustrate example tokenized card payment operations for a new card according to implementations described herein.

FIGS. 15A and 15B illustrate example tokenized card payment operations for a card on file according to implementations described herein.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. The terms “vendor” and “merchant” used herein mean a person or entity offering goods or services for sale (e.g., food, fuel, parking, accommodations, etc.). Additionally, the terms “vendor” and “merchant” are used interchangeably herein, and neither term is intended to limit the types of goods or services offered by a person or entity. While implementations will be described for mobile computing device applications, it will become evident to those skilled in the art that the implementations are not limited thereto, but are applicable for other device applications such as Internet-connected televisions, vehicles, and/or consumer appliances.

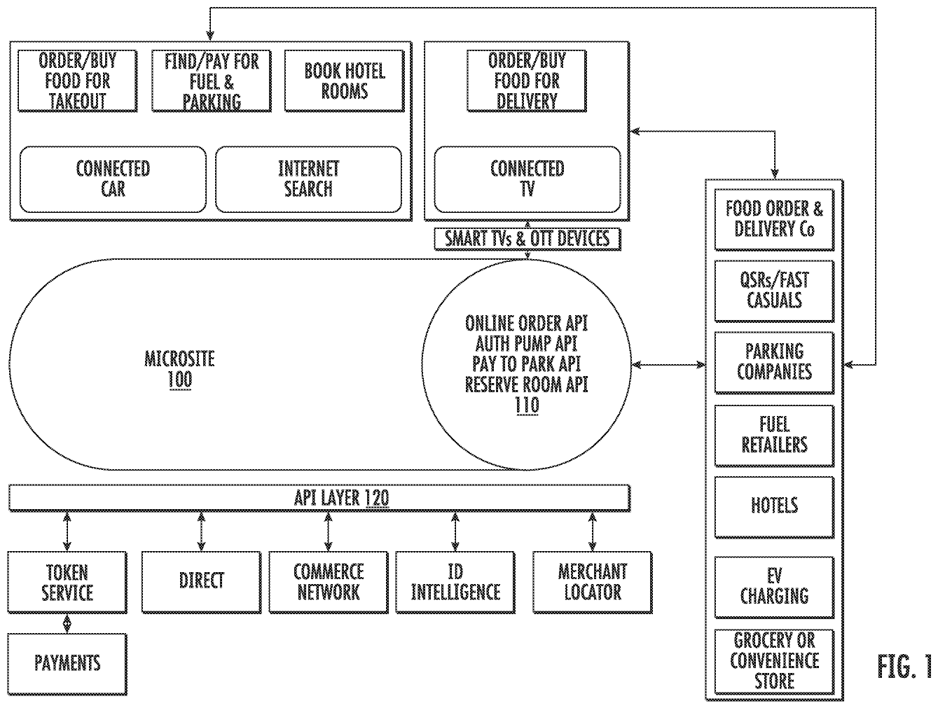

Referring now to FIG. 1, a diagram illustrating an example microsite 100 is shown. This disclosure contemplates that the methods for facilitating mobile payment transactions with a plurality of merchants can be conducted using a microsite 100. A microsite is one or more webpages with a specific, targeted purpose. In some conventional applications known in the art, a microsite is nested within a parent website, and the microsite may be used for a specific purpose such as a targeted marketing campaign. As used herein, the microsite 100 is a standalone site. For example, the microsite 100 has its own domain name. The microsite 100 is also adaptive such that the user's experience at the microsite 100 is conditioned upon how the user enters the microsite. For example, when a user enters the microsite 100 to interface with a parking company, the user's experience at the microsite 100 is tailored to the parking experience. On the other hand, when a user enters the microsite 100 to interface with a restaurant, the user's experience at the microsite 100 is tailored to the dining or takeout experience. The microsite 100 is therefore adapted to the particular application. This is facilitated by the type of vendor content that is transmitted to the user's device as described herein. It should be understood that a parking company and restaurant are provided only as examples. As described herein, the specific purpose of the microsite 100 is to facilitate mobile payment transactions with multiple merchants (i.e., “one-to-many” as described below). For example, the microsite 100 can transmit payment authorization requests on behalf of multiple merchants, for example, via a payment gateway to each merchant's particular payment processor in the payment network. The merchants remain the merchants of record in these transactions. The microsite 100 therefore acts as a surrogate for the merchants to facilitate the transactions.

The microsite 100 provides a user (e.g., consumer) with a location-specific experience and specific content triggered by what information (e.g., vendor content) is passed from a vendor application (e.g., fuel/gas/electric charge, restaurant, food, hospitality, etc.). This can optionally include the branding, offer (e.g., product/service) details, purchasing flow, etc. It should be understood that vendor content for different vendors would be different. The microsite 100 is used to tailor the user's experience to a particular vendor's processes and/or requirements. As described herein, this disclosure contemplates initiating transactions from the vendor, for example using any number of means such as the user scanning a barcode (e.g., two-dimensional code such as QR code) at the merchant location, conducting an Internet search, or interacting with a vendor-controlled mobile application (“app”).

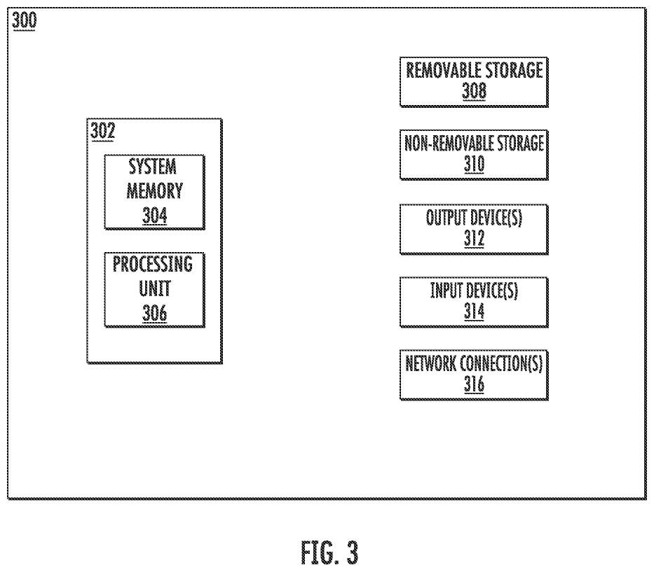

Additionally, the microsite 100 can be hosted at a server (e.g., computing device 300 of FIG. 3). A user's device (e.g., computing device 300 of FIG. 3) can be operably coupled to the microsite 100 by one or more networks. The user's device is optionally a mobile computing device such as a smart phone, tablet computer, smart watch, etc. In other implementations described herein, the user's device is optionally an Internet-connected device such as a television (e.g., “connected TV” in FIG. 1), an appliance, or a vehicle (e.g., “connected car” in FIG. 1). This disclosure contemplates that the networks are any suitable communication network. The networks can be similar to each other in one or more respects. Alternatively or additionally, the networks can be different from each other in one or more respects. The networks can include a local area network (LAN), a wireless local area network (WLAN), a wide area network (WAN), a metropolitan area network (MAN), a virtual private network (VPN), etc., including portions or combinations of any of the above networks. The mobile computing device and the microsite 100 discussed above can be coupled to the networks through one or more communication links. This disclosure contemplates the communication links are any suitable communication link. For example, a communication link may be implemented by any medium that facilitates data exchange between the mobile computing device and the microsite 100 including, but not limited to, wired, wireless and optical links. Example communication links include, but are not limited to, a LAN, a WAN, a MAN, Ethernet, the Internet, or any other wired or wireless link such as WiFi, WiMax, 3G, 4G, or 5G.

Software running on the user's mobile computing device interacts with the microsite 100 via one or more application program interfaces (APIs) 110. An API is an interface and/or communication protocol that allows software applications to interact with one another. APIs are known in the art and are therefore not described in further detail herein. As shown in FIG. 1, the microsite 100 includes a plurality of APIs 110 (e.g., APIs for restaurant/food delivery, fuel, parking, hospitality, electric vehicle (EV) charging, and grocery/convenience store) to facilitate interactions with the user's device and/or the vendors. It should be understood that the number of APIs is provided only as an example in FIG. 1. This disclosure contemplates providing APIs for other types of vendors. Additionally, the microsite 100 includes an API layer 120 configured to interact with software of a payment processor.

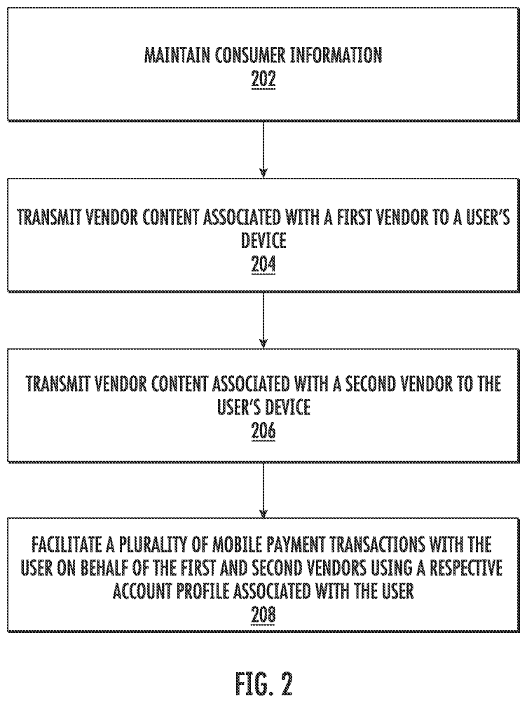

Referring now to FIG. 2, an example computer-implemented method for facilitating mobile payment transactions with a plurality of merchants is shown. The techniques described herein facilitate the concept of “one-to-many,” e.g., using a microsite to facilitate mobile payment transactions between a user and multiple merchants. This disclosure contemplates that the payment transactions may include e-commerce (e.g., online, mobile, digital, etc.) transactions; credit, charge, or debit card transactions; person-to-person (P2P) or person-to-business (P2B); or other electronic funds transactions. As described below, in some implementations, the user creates an account at a microsite (e.g., microsite 100 of FIG. 1). For example, the user can create the account at the microsite using a computing device such as a mobile computing device. The microsite allows the user to access an account profile (e.g., personal, financial, payment, etc. information) for the user in the user's account, which is maintained by a server. The user's account profile can optionally include other information that meets the requirements dictated by individual vendors and/or the vendors' payment processors to complete transactions. For example, the user's account profile can include different types of information needed by different vendors including, but not limited to, a license plate number for parking, the make and model of vehicle for curbside pick-up, an email or phone number associated with recent food orders for quick re-ordering. Once entered, this information is stored in the user's account profile for future use. The account profile is then used to facilitate mobile payment transactions with multiple merchants. Accordingly, the user is not required to create individual accounts with each of the merchants. In other words, a single account profile for the user is used to facilitate mobile payment transactions with different merchants (i.e., “one-to-many”). In other implementations, the user's account is automatically created by the microsite. For example, a third party such as a merchant can provide information for the user's account to the microsite via an API (e.g., APIs 110). In other words, the third party has already collected the user's information and transmits such information to the microsite, which creates the user's account. In these implementations, the user is automatically enrolled such that the user is not required to create another account (e.g., a first account with the third party and a second account with the microsite). As described herein, once the user's account is established, the user's account profile can be used to facilitate mobile payment transactions with different merchants. Additionally, the techniques described herein do not require the user to download and install an app. Instead, the microsite can be accessed by the user with a mobile web app, which can be accessed using the native web browser.

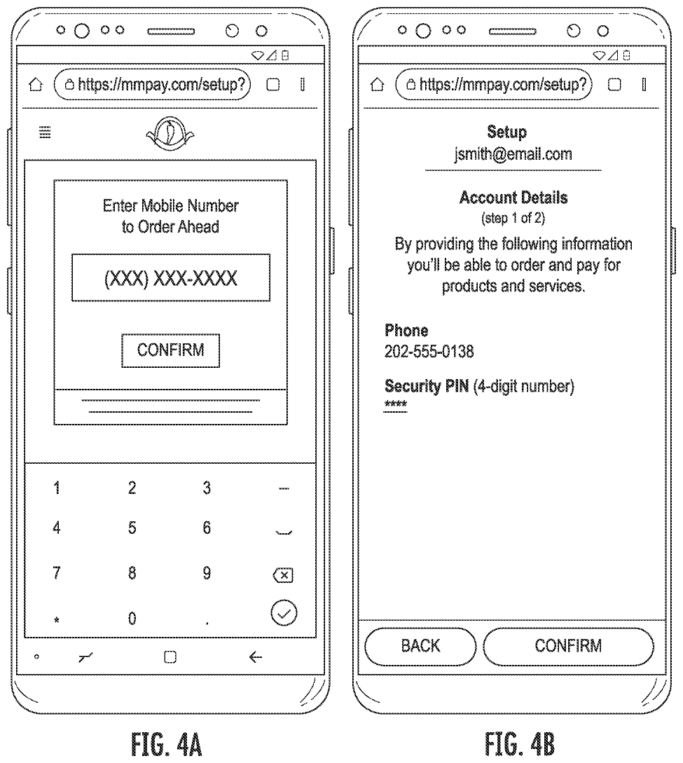

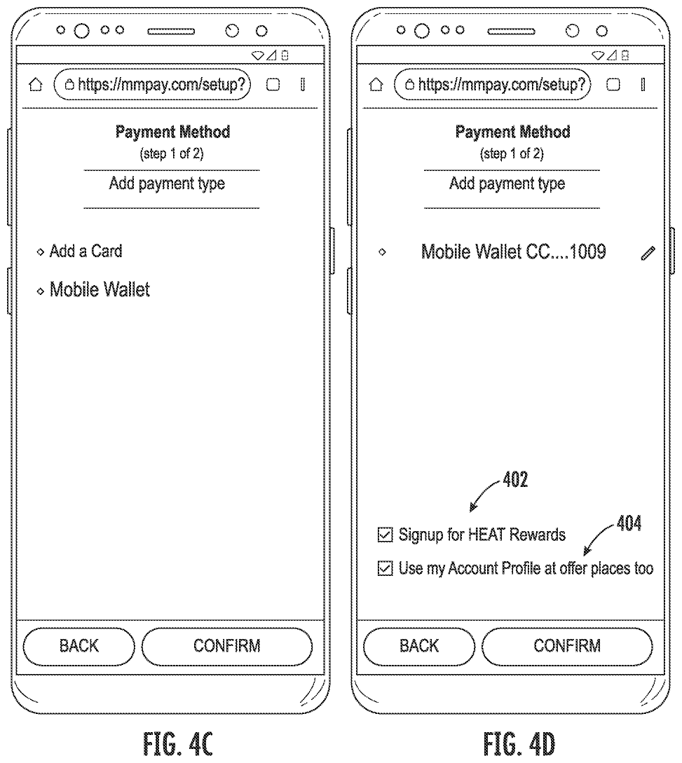

At step 202, consumer information is maintained, for example, by a server (e.g., computing device 300 of FIG. 3). Optionally, the consumer information is stored in memory of the server, for example in a database. For example, users can create accounts at the microsite (e.g., microsite 100 of FIG. 1) or the microsite automatically creates the user's account with information received from a vendor. The microsite is used to display and capture information used by the server to facilitate transactions with the users. The microsite does not store information for extended periods of time. Instead, the microsite retains information only for short periods of time needed to facilitate transactions. Thereafter, information is deleted from the microsite, which increases security of the microsite. As discussed above, the consumer information is stored by the server. The consumer information includes a plurality of respective account profiles associated with a plurality of consumers. In other words, a respective account profile is associated with each respective consumer. An account profile includes personal information (e.g., name, address, phone number, etc.), financial information (e.g., bank account(s), credit card number(s), digital wallet(s) or e-wallet(s), etc.), and/or payment method information (e.g., which bank account, credit card, and/or digital wallet to use for the mobile payment transactions). Additionally, the account profile can include other information needed to facilitate transactions such as license plate number, make and model of a vehicle, etc. It should be understood that the type of information included in an account profile is not limited. FIGS. 4A-4D illustrate an example process for creating an account at a microsite using a mobile computing device (e.g., smart phone). In FIG. 4A, the user creates an account at the microsite using the user's mobile number. In FIG. 4B, the user provides account information including, but not limited to, a security code such as a personal identification number (PIN). Optionally, the user can provide other personal information such as a name and/or address. In FIG. 4C, the user provides financial information such as a credit card number and/or digital wallet. In FIG. 4D, the user provides payment method information (e.g., Mobile Wallet). Reference numbers 402 and 404 illustrate opt-ins for rewards program and use of the user's account profile with other merchants, respectively. Alternatively or additionally, an account profile optionally includes a token. In some implementations, an account profile can include a plurality of tokens, e.g., a respective token for each payment method. It should be understood that respective information for each account, credit card, etc. can be tokenized separately. In some implementations, at least a portion (e.g., financial information) of the account profile can be tokenized. For example, the microsite can connect to a token management service (TMS) that provides tokenization services for credit cards, debit cards, digital wallets, bank accounts, etc. Tokenization exchanges sensitive payment data for unique identifiers (i.e., tokens). The unique identifiers are difficult, if not impossible, to hack. The tokens can be shared on the payment network as part of the transaction, while the underlying sensitive payment data is securely retained by the TMS. The TMS enables elements of the underlying payment method, like expiration date, to be updated so the payment method remains valid over time. Additionally, the TMS has capacity to transition payment methods from localized card on file tokens to network tokens. Tokenization is known in the art and therefore not described in further detail herein.

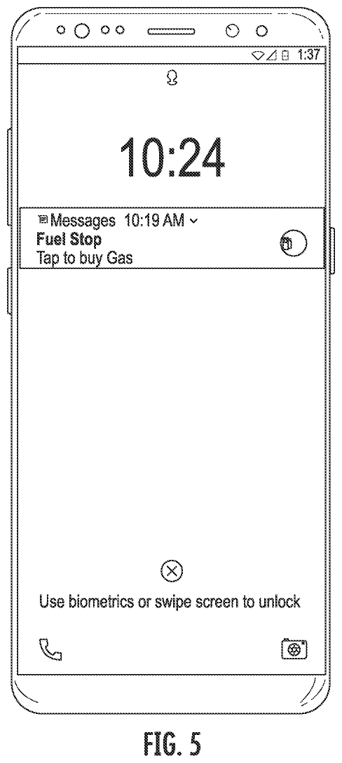

Referring again to FIG. 2, vendor content associated with a first vendor is transmitted to the user's mobile computing device at step 204. Additionally, at step 206, vendor content associated with a second vendor is transmitted to the user's mobile computing device. The vendors can include, but are not limited to, a fuel retailer, an electric vehicle charging company, a convenience store, a grocery store, a restaurant, a parking company, a hotel or motel. It should be understood that the vendors are not limited to the examples provided above. It should also be understood that the first and second vendors are different vendors. For example, the first and second vendors can be different types of vendors (e.g., a gas station and a restaurant). Alternatively, the first and second vendors can be different vendors of the same type (e.g., two different gas stations). The vendor content can be tailored to the particular vendor's processes and/or requirements. For example, the vendor content for a parking service can be different than the vendor content for a restaurant. As described herein, the microsite (e.g., microsite 100 of FIG. 1) is used to facilitate mobile payment transactions with multiple merchants. In some implementations, the vendor content is an offer for a good or service. In some implementations, the vendor content is a menu. Optionally, the vendor content is configured for display on the user's mobile computing device. The vendor content is tailored to the particular vendor. Example vendor content is shown in FIGS. 5-9D. Optionally, the vendor content transmitted to the user's mobile computing device at step 204 and/or step 206 can be customized, for example, based on the vendor type, brand, location, day, time of day, and/or other factors used to determine what products or services are available to be purchased at the time of the interaction. Alternatively or additionally, the vendor content can include user-specific information such as the user's order history, recently placed orders, and/or items or services identified as favorites or preferred.

Vendor information associated with a plurality of vendors can be maintained or accessed by a microsite (e.g., microsite 100 of FIG. 1). Optionally, vendor information is stored in memory of the server, for example in a database. Optionally, the microsite, which can be operably connected to the vendor systems over a network, can access the vendor systems to obtain vendor information. For example, because vendor information (e.g., product pricing, availability, assortment, etc.) is subject to change, the microsite can interface with the vendors' systems, for example using APIs (e.g., APIs 110 of FIG. 1), in real-time on each transaction. Optionally, the microsite can retain vendor data related to past purchases to support streamlined ordering of previously purchased (e.g., recent) products or services. Such information can be maintained in the user's account at the server. Additionally, the microsite is configured on a per-vendor basis depending upon the vendor's eCommerce systems and/or the product or service being offered to the consumer. For example, a restaurant chain may have developed and may operate its own online and mobile ordering applications connecting directly to each restaurant location's point of sale (POS) system. The microsite can access the restaurant-provided endpoints (i.e., the APIs) to complete an order. Additionally, some vendors may use third party online ordering services. Examples include, but are not limited to, services offered by companies like Olo, Tillster, Netwaiter and others. The microsite can access the third party system's APIs on behalf of the vendor to complete an order.

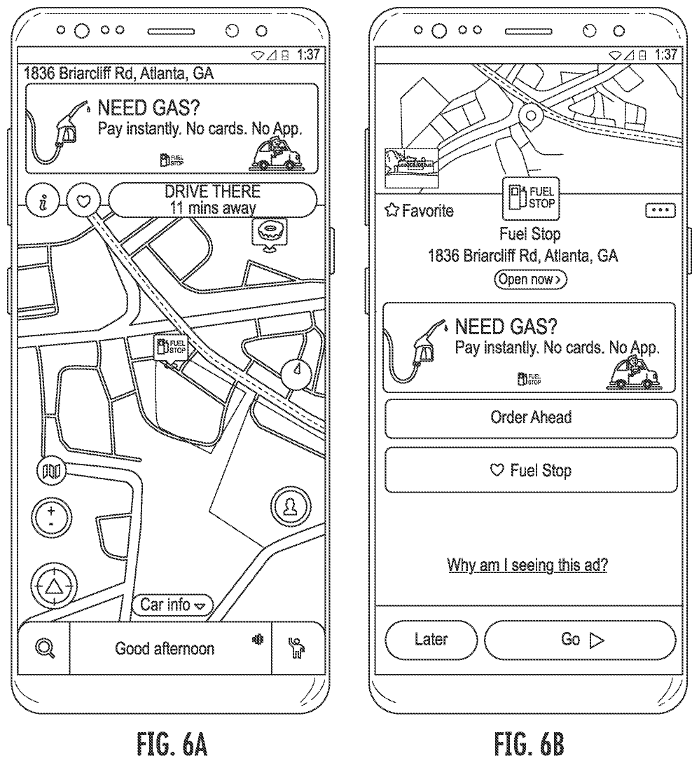

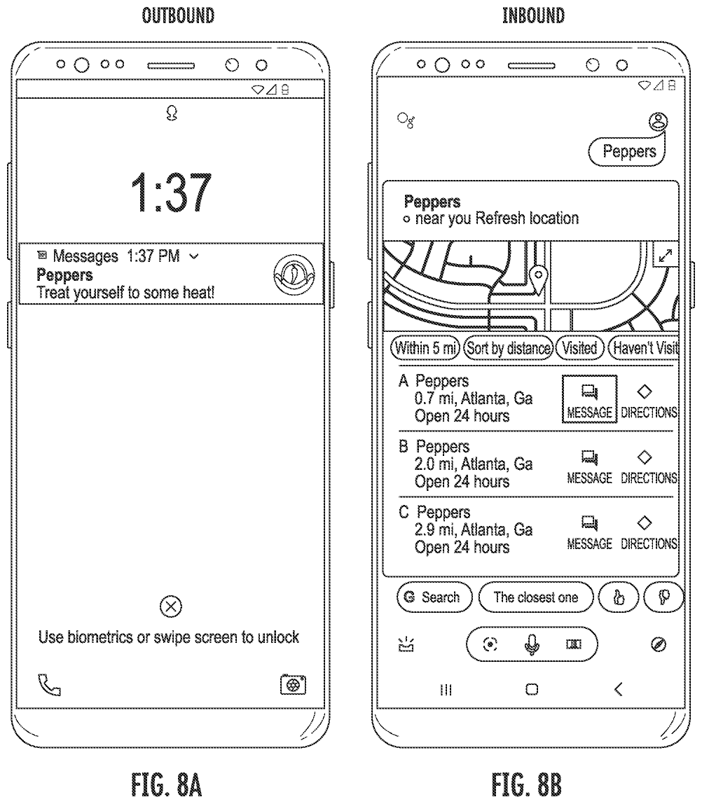

Additionally, the vendor content transmitted to the user's mobile computing device at step 204 and/or step 206 can optionally be transmitted over a network using a messaging service including, but not limited to, text messaging, instant messaging, rich communication services (RCS) messaging and/or rich business messaging (RBM). Examples are shown in FIG. 5 (e.g., offer for fuel/gas) and FIG. 8A (e.g., offer for food). Alternatively or additionally, the vendor content transmitted to the user's mobile computing device at step 204 and/or step 206 can optionally be transmitted over a network using a mobile web app associated with the microsite. The mobile web app can be accessed using the user's mobile computing device using a mobile web browser. Alternatively or additionally, the vendor content transmitted to the user's mobile computing device at step 204 and/or step 206 can optionally be transmitted over a network to an app running on the user's mobile computing device. This disclosure contemplates that the app can be associated with a vendor. Examples are shown in FIGS. 6A-6B, 7A-7C, 8B, and 9A-9D. In some implementations, the vendor content transmitted to the user's mobile computing device at step 204 and/or step 206 can optionally be transmitted using both a messaging service and an app. Depending on the complexity of the transaction, all of the vendor content is transmitted via messaging service. Alternatively, a portion of the vendor content is transmitted via messaging service, while a portion of the vendor content is transmitted via the app. For example, messaging can be used during the initial stages of the transaction to provide context to the transaction before being handed off to the app.

In some implementations, the vendor content transmitted to the user's mobile computing device at step 204 and/or step 206 can optionally be transmitted based on a location of the user's mobile computing device. This is sometimes referred to as “geofencing” a vendor's location. In other words, the location-based action (e.g., vendor content transmission) is triggered when the user crosses a geofence. FIGS. 6A and 6B are examples of geofenced messaging for fuel/gas. For example, when a consumer crosses a geofence of a gas station, the consumer is presented with a message indicating a fast-fuel option on the consumer's mobile computing device. This disclosure contemplates that geofencing vendor location can be handled by a partner app that hands off transactions to the microsite (e.g., microsite 100 of FIG. 1). Examples may include a mapping app (e.g., Google Maps) or other location based app (e.g., Google My Business). This disclosure contemplates that geofencing can be provided by any location-based app. In other implementations, the microsite can provide the partner app with locations based on the location of the user's mobile computing device (e.g., global positioning system (GPS coordinate), latitude/longitude, etc.). The locations returned by the user's mobile computing device can optionally be filtered by category (e.g., parking, fuel, dining, etc.).

As described herein, transactions may be initiated from the vendor's system or service. For example, the user may scan a barcode (e.g., one dimensional code, two dimensional or QR code, etc.) with the mobile computing device at the vendor's location (e.g., gas station, restaurant, hotel). Alternatively, the user may conduct an Internet search. Alternatively, the user may interact with a vendor-controlled app, e.g., the user selects a deep link (e.g., as shown in FIGS. 6A, 6B, and 8B) embedded within a call-to-action button like “Buy Gas” or “Order Food,” which redirects the user to the microsite. Alternatively or additionally, transactions may be initiated using contact-less short-range wireless communication, for example near field communication (NFC), at the vendor's location. Alternatively or additionally, transactions may be initiated based on the user's location. After initiation, the vendor content is transmitted to the user's mobile computing device as described herein. At step 208, a plurality of mobile payment transactions are facilitated with the user on behalf of the first and second vendors using a respective account profile associated with the user. This includes separately facilitating respective mobile payment transactions with the user on behalf of each of a plurality of vendors. For example, a first mobile payment transaction is facilitated with the user on behalf of a first vendor using the respective account profile associated with the user, and a second mobile payment transaction is facilitated with the user on behalf of a second vendor using the respective account profile associated with the user. The first vendor and the second vendor are merchant of record for the first and second mobile payment transactions, respectively. The authorization request for each mobile payment transaction therefore includes information about the consumer (i.e., information from the respective account profile for the user) and information about the particular vendor. The server and/or microsite acts as a surrogate for the first and second vendors in the first and second mobile payment transactions, respectively. It should be understood that the same account profile is used for each of these separate transactions (e.g., “one-to-many”). It should also be understood that the number of vendors can be greater than two, for example, the method described above can be used to facilitate mobile payment transactions with three, four, five, six, or any number of vendors using the same account profile.

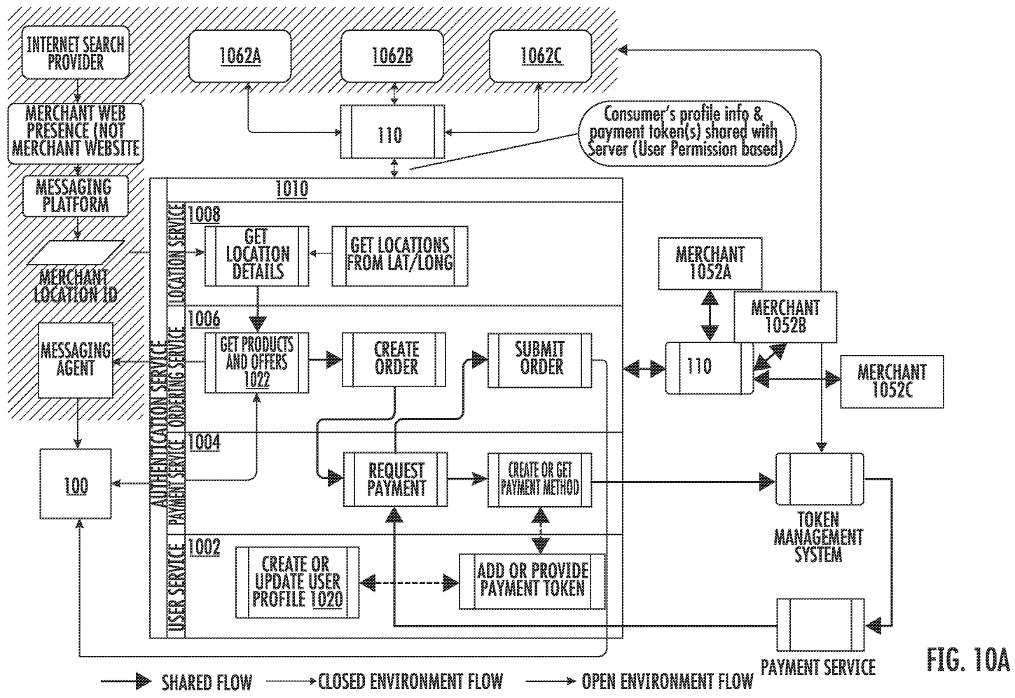

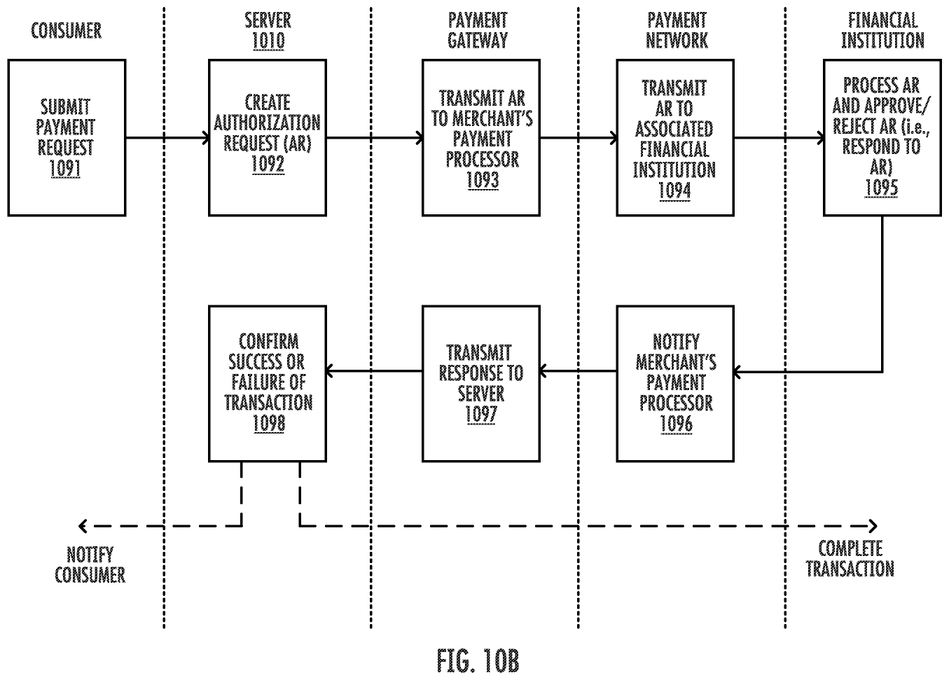

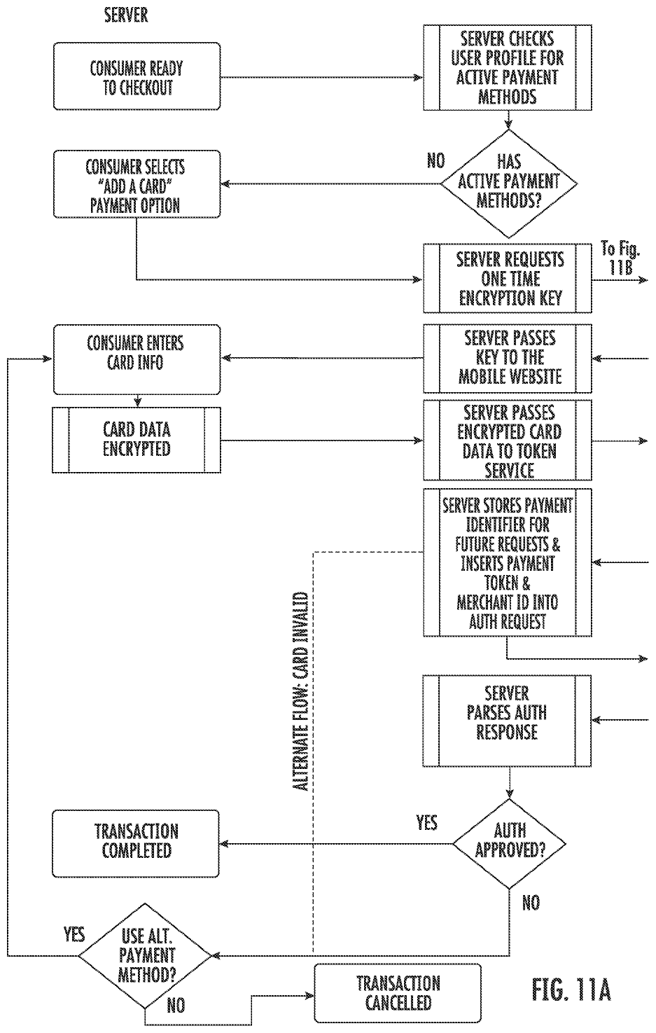

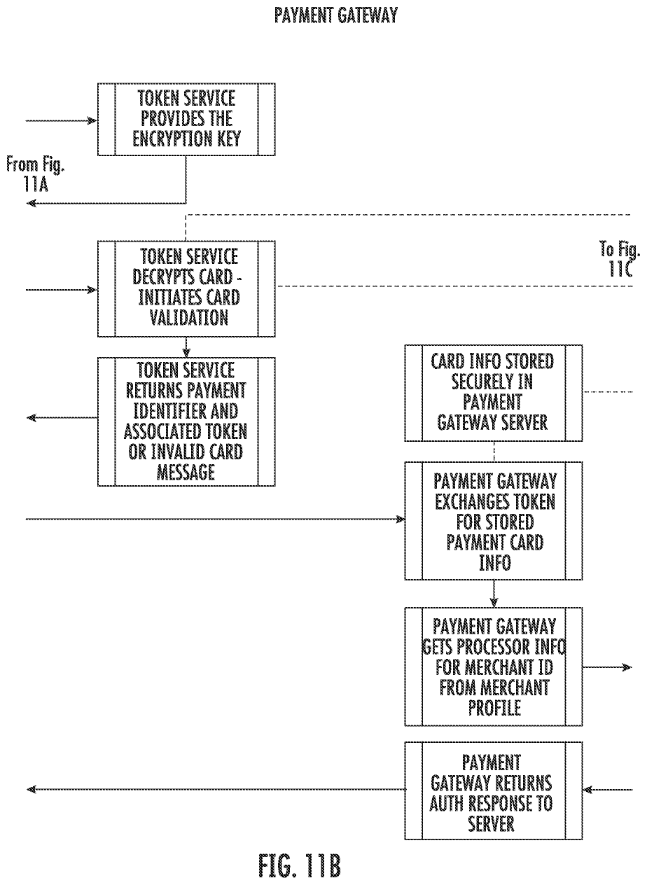

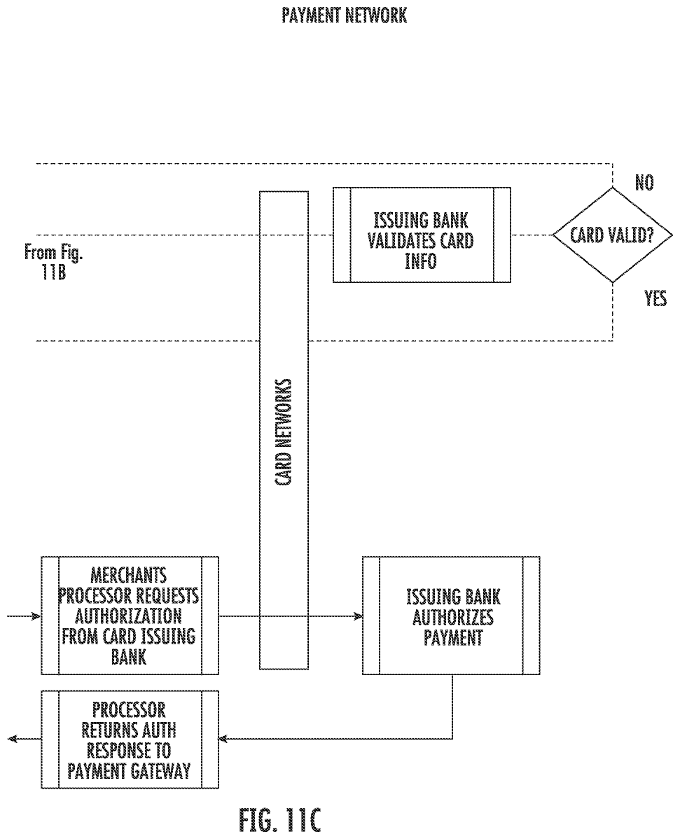

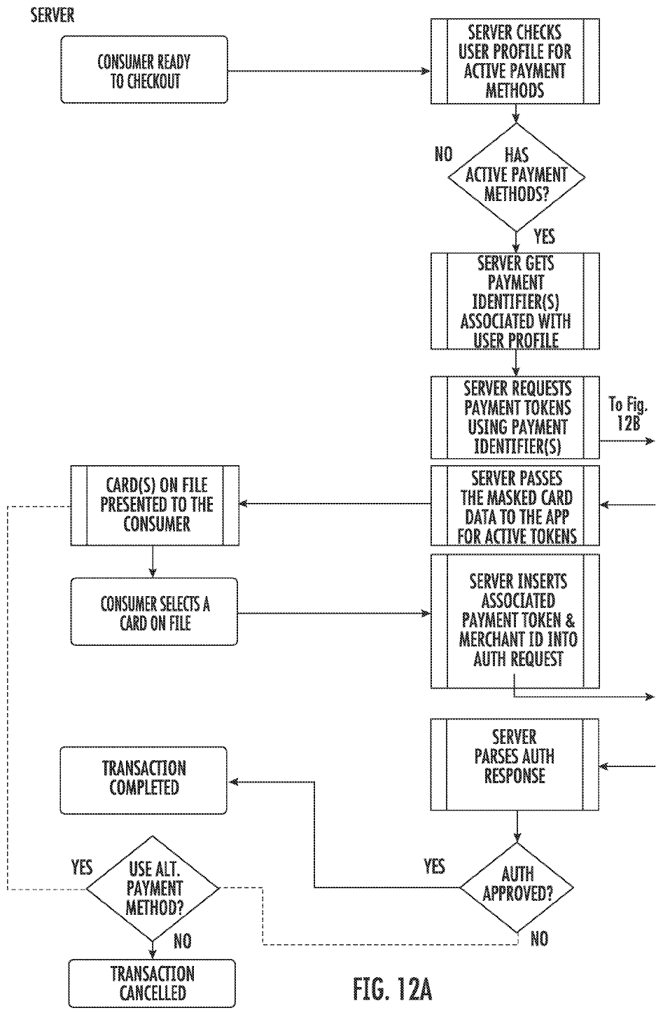

Referring now to FIG. 10A, an example operating environment 1000 is shown. The environment 1000 is used to facilitate the concept of “one-to-many,” e.g., facilitating mobile payment transactions between a consumer and multiple merchants 1052A, 105213, 1052C (collectively referred to herein as “merchants 1052”). As described herein, merchants 1052 can include, but are not limited to, a fuel retailer, an electric vehicle charging company, a convenience store, a grocery store, a restaurant, a parking company, a hotel or motel. It should be understood that the number and/or type of merchants 1052 are not limited to those shown in FIG. 10A. Additionally, as described herein, the consumer can interact with a microsite 100 using a user device including, but not limited to, a mobile computing device 1062A (e.g., a smartphone or tablet), a connected appliance 10626 (e.g., an Internet of Things (IoT) device), or a connected vehicle 1062C (individually referred to herein as “user device 1062”). It should be understood that the type of user device 1062 is not limited by those shown in FIG. 10A. The environment 1000 also includes one or more APIs 110 through which the merchants 1052 and/or the user device 1062 interact with a server 1010 (e.g., computing device 300 of FIG. 3).

As shown in FIG. 10A, the server 1010 optionally provides a user service 1002, a payment service 1004, an ordering service 1006, and a location service 1008. The user service 1002 allows the consumer (or optionally a third party on the consumer's behalf, e.g. through auto-enrollment) to create an account profile 1020. As described herein, the consumer's account profile includes personal, financial, payment, etc. information needed to complete payment transactions. The consumer's account profile can optionally further include other information that meets the requirements dictated by individual merchants 1052 and/or the payment processors to complete payment transactions. As described herein, the consumer's account profile is used to facilitate mobile payment transactions with multiple merchants 1052. In other words, a single account profile for the consumer is used to facilitate mobile payment transactions with different merchants (i.e., “one-to-many”). The server 1010 interfaces with the merchants' systems, for example, using the APIs 110.

The ordering service 1006 allows the merchants 1052 to transmit content 1022 (e.g., offers for goods and/or services) to the user device 1062. As described herein, the content 1022 can optionally be tailored to the particular merchant's processes and/or requirements. Alternatively or additionally, the content 1022 can optionally be customized, for example, based on the merchant type, brand, location, day, time of day, available products or services, and/or user-specific information such as the customer's order history, recently placed orders, and/or items or services identified as favorites or preferred. This disclosure contemplates that the ordering service 1006 provides such functionality. For example, in some implementations, information associated with one or more of the merchants 1052 is stored in memory of server 1010, for example in a database. Alternatively or additionally, in some implementations, the server 1010 is operably connected to the merchants systems over a network such that the server 1010 can access the merchants' information and create the content 1022. This allows the server 1010 to interface with the merchants' systems in real-time on each transaction. As described herein, the content 1022 can be transmitted to the user device 1062 over a network using a messaging service including, but not limited to, text messaging, instant messaging, RCS messaging and/or RBM. Alternatively or additionally, the content 1022 can be transmitted to the user device 1062 over a network using a mobile web app associated with the microsite 100.

The payment service 1004 facilitates a plurality of mobile payment transactions between the consumer on behalf of a plurality of merchants 1052 using the same account profile associated with the consumer. This disclosure contemplates that the payment transactions may include e-commerce (e.g., online, mobile, digital, etc.) transactions; credit, charge, or debit card transactions; person-to-person (P2P) or person-to-business (P2B); or other electronic funds transactions. Techniques for facilitating mobile payment transactions according to implementations of this disclosure are described below. For example, referring now to FIG. 10B, a flow diagram illustrating example operations for facilitating mobile payment transactions with the merchants 1052 of FIG. 10A is shown. It should be understood that while FIG. 1013 illustrates operations for facilitating a mobile payment between the consumer and one merchant, the operations for facilitating mobile payments with additional merchants is the same. In other words, the operations for facilitating a mobile payment can be repeated for each transaction between the consumer and a merchant.

At 1091, the consumer initiates a payment request. For example, the consumer purchases goods and/or services from one of the merchants 1052 of FIG. 10A. As described herein, the transaction between the consumer and the merchant may be initiated in a number of ways. For example, the consumer may scan a barcode with a mobile computing device or use contact-less short-range wireless communication at the merchant's location. Alternatively, the user may conduct an Internet search. Alternatively, the consumer may interact with a merchant-controlled app, e.g., the consumer selects a deep link embedded within a call-to-action button like “Buy Gas” or “Order Food,” which redirects the consumer to a microsite.

At 1092, the server 1010 creates an authorization request. As described herein, the server 1010 maintains respective account profiles for a plurality of consumers. Each respective consumer account profile includes personal, financial, payment, etc. information needed to complete payment transactions. Each respective consumer account profile can also optionally include other information that meets the requirements dictated by individual merchants and/or the payment processors to complete payment transactions. As described herein, the server 1010 also maintains information about the merchants. The server 1010 acts as a surrogate for the merchants 1052 of FIG. 10A. Thus, the server 1010 can create an authorization request for a particular merchant (i.e., the merchant of record) that includes information from the respective account profile for the consumer. The information from the respective account profile may include credit card, debit card, digital wallet, and/or bank account information (sometimes referred to herein as “payment account number (PAN)”). Optionally, such information may be encrypted. Alternatively or additionally, the information from the respective account profile may be a token. The information from the respective account profile, which may include encrypted PAN and/or a token, can be used to facilitate payment transactions with a plurality of different merchants. In other words, the information from the respective account profile is used universally to facilitate payment transaction with different merchants. Thus, it should be understood that the server 1010 can create authorization requests for a plurality of different merchants using information from the same account profile for the consumer. This is “one to many” as described herein, i.e., a single account profile for the consumer is used to facilitate mobile payment transactions with different merchants.

The server 1010 then transmits the authorization request to the payment gateway as shown in FIG. 10B. The payment gateway securely authorizes payment transactions. Payment gateways are known in the art and therefore not described in further detail herein. In some implementations, the payment gateway decrypts the information from the respective account profile, which is included with the authorization request, before further processing. Alternatively or additionally, the payment gateway converts a token, which is optionally included with the authorization request, back to the PAN (e.g., credit card, debit card, account, etc. number) before further processing. At 1093, the payment gateway transmits the authorization request to the payment network. This includes transmitting the authorization request to a payment processor for the merchant of record. A payment processor is the entity (e.g., a bank) that performs functions such as payment switching and settlement for the merchant of record. Payment processors are known in the art and therefore not described in further detail herein. It should be understood that there are a number of payment processing entities and that the payment gateway communicates the authorization request to the particular payment processor for the merchant of record.

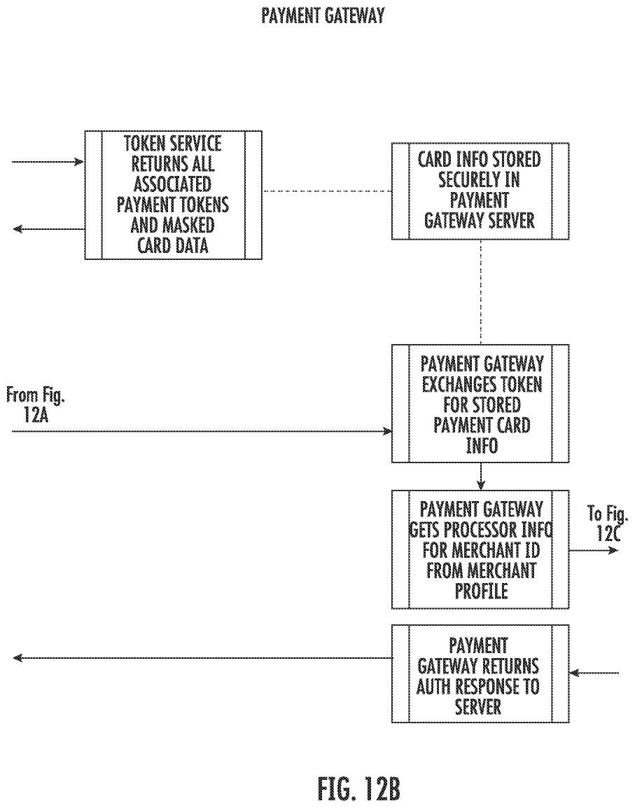

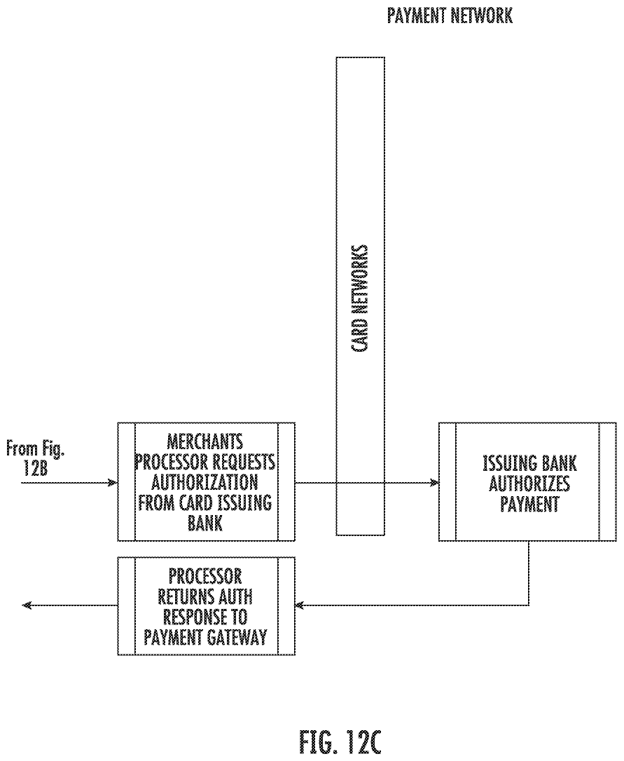

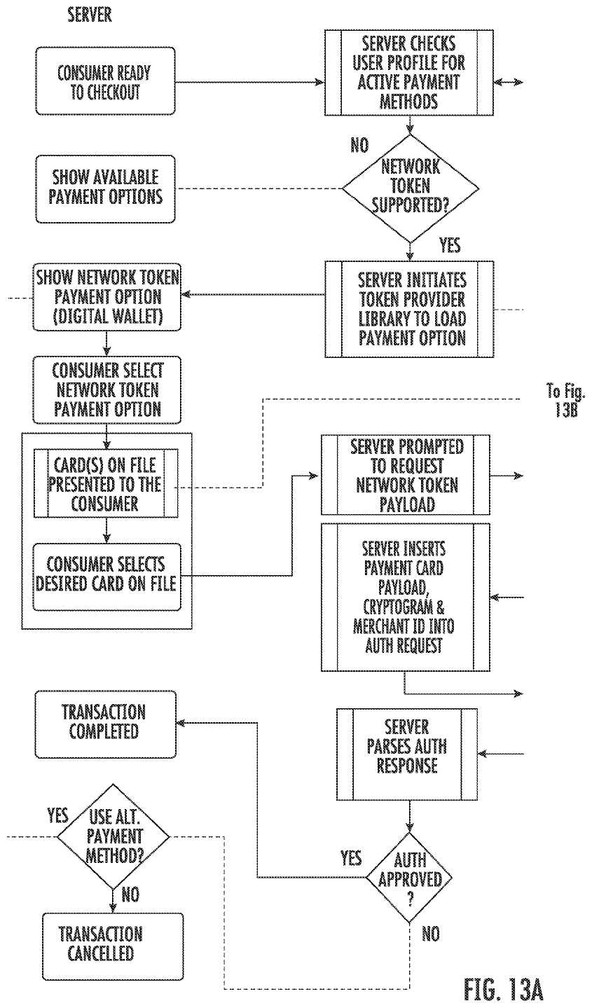

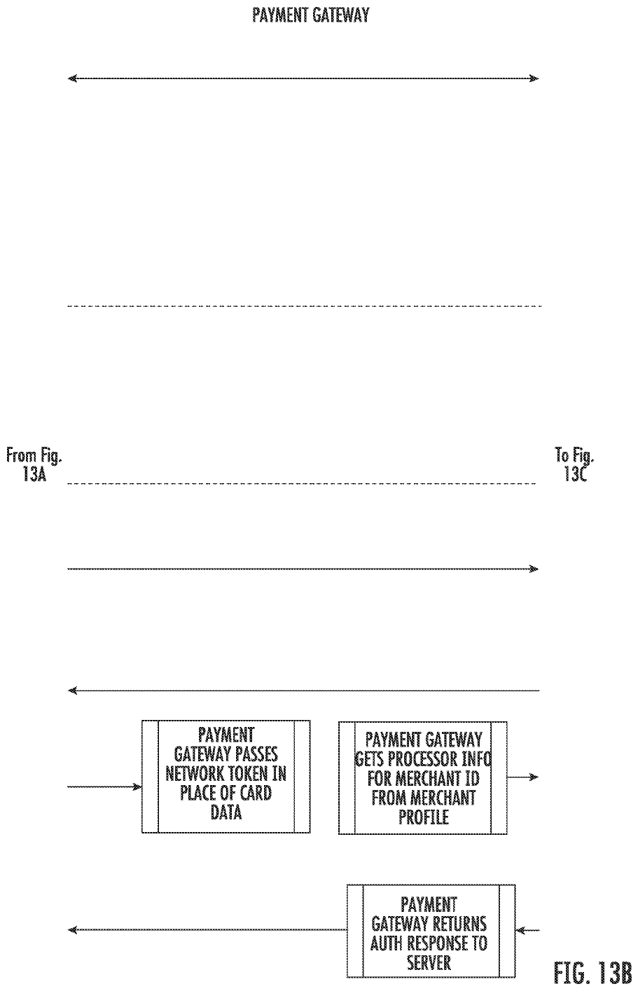

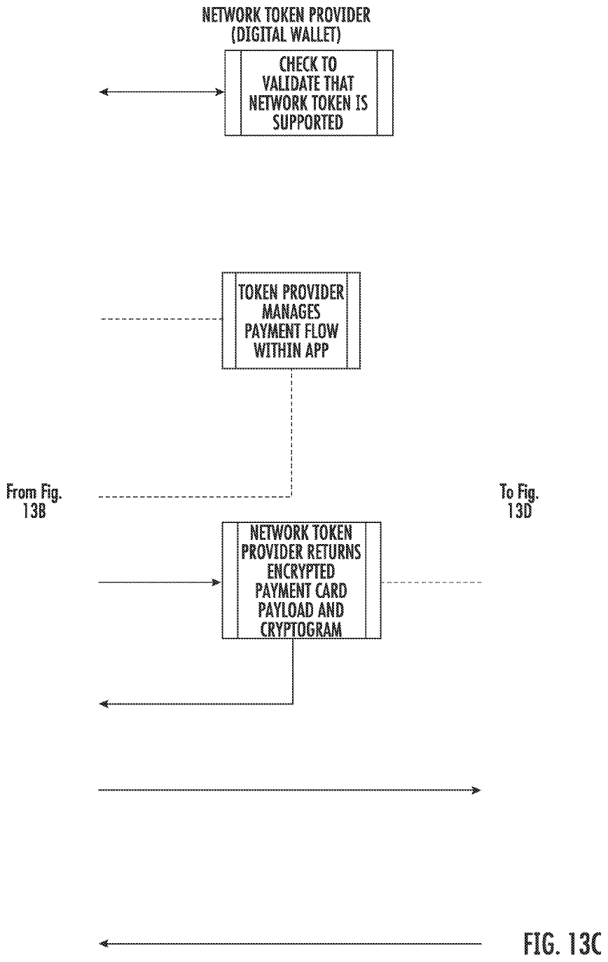

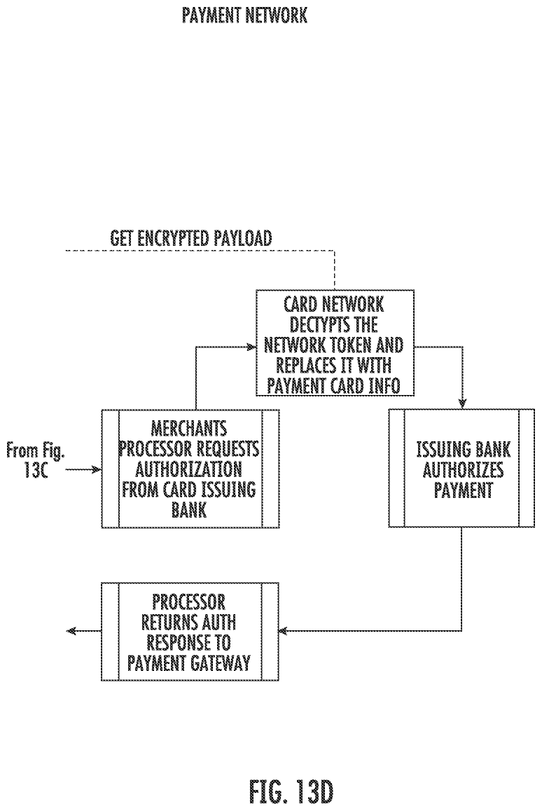

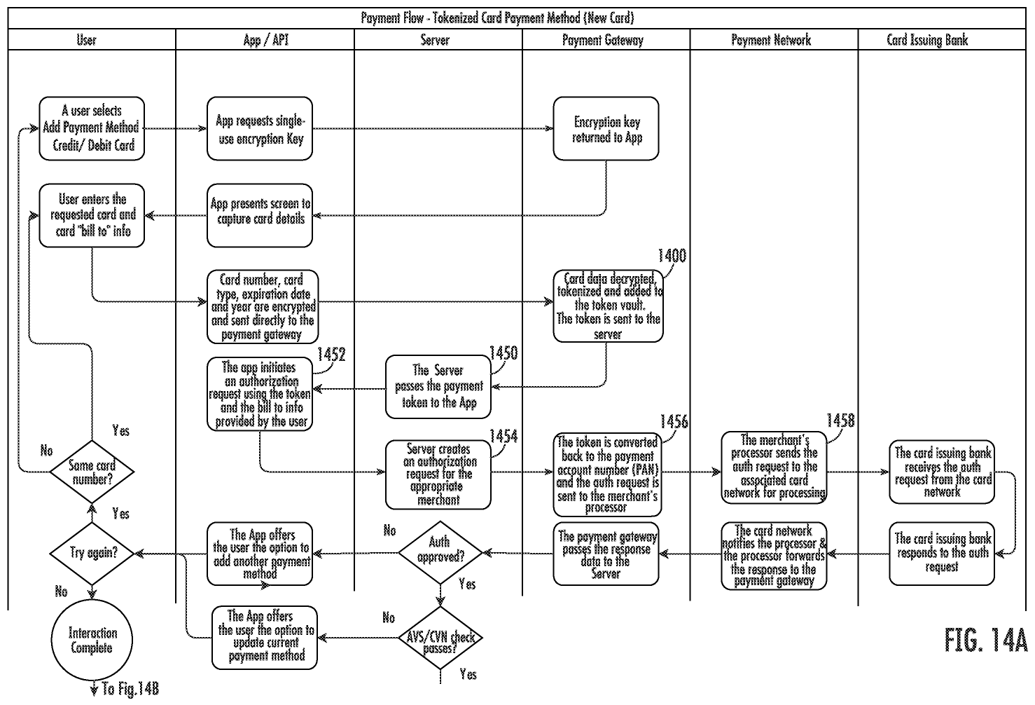

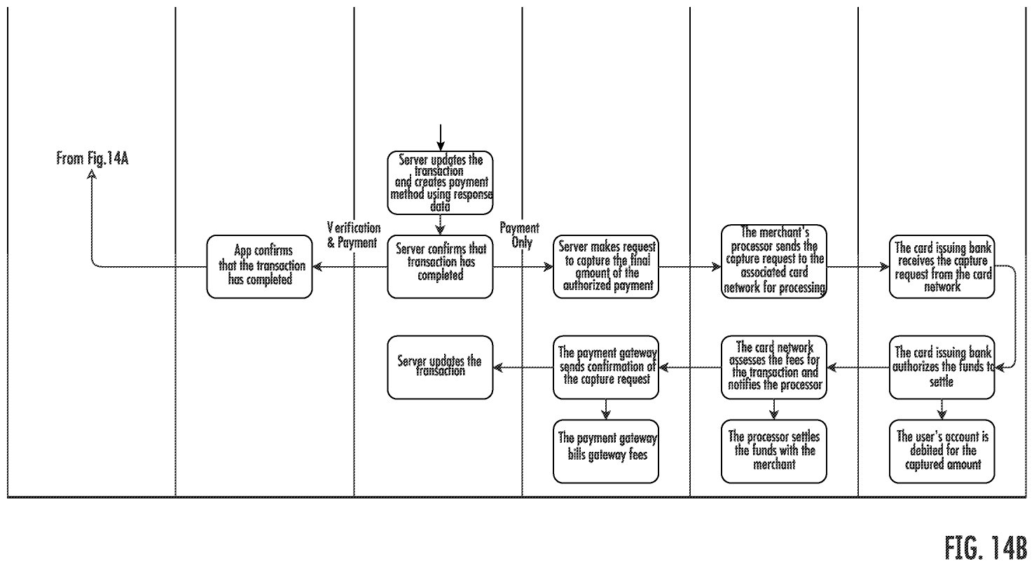

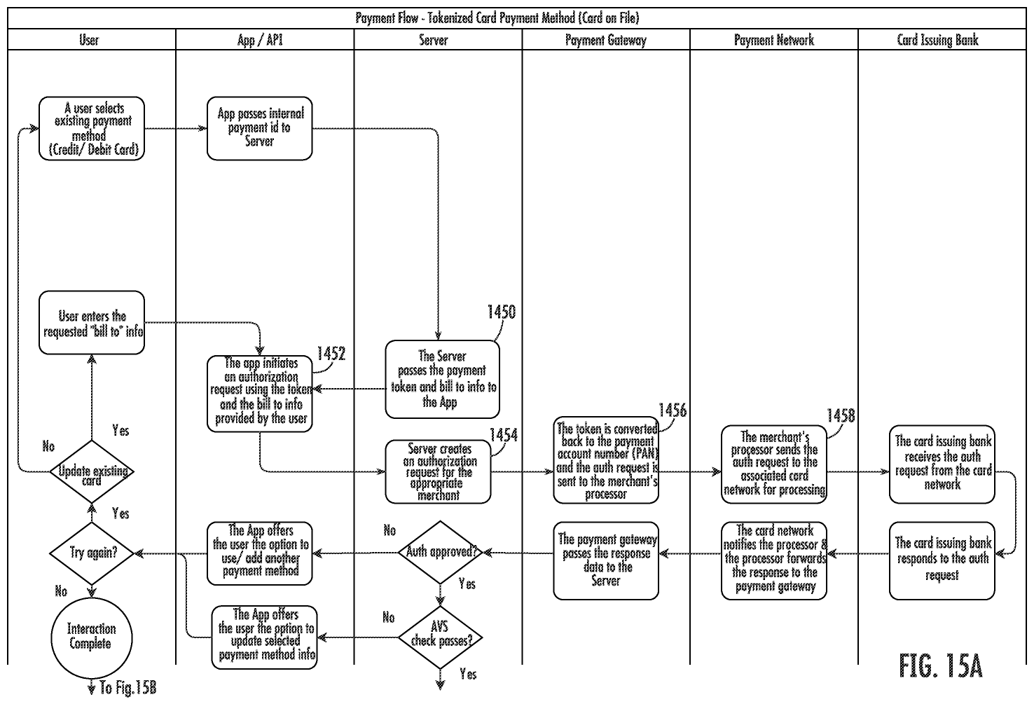

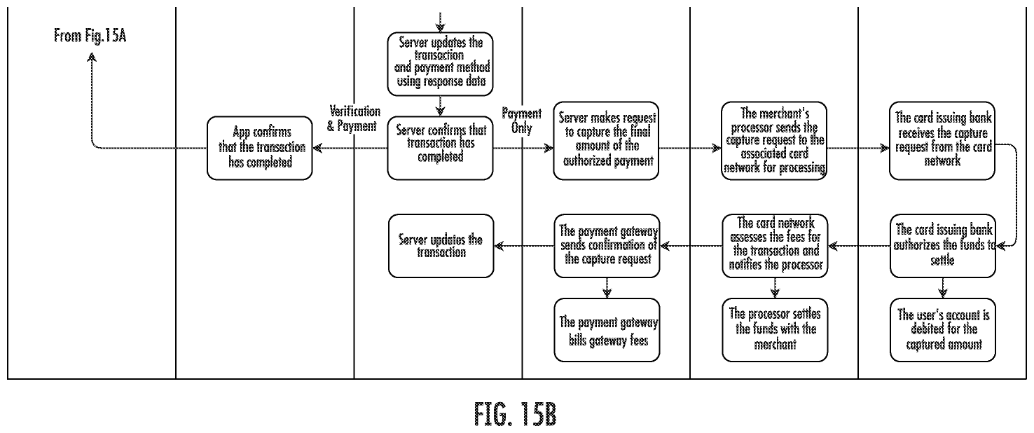

At 1094, the payment processor for the merchant of record transmits the authorization request to a financial institution. For example, the financial institution may be the issuing bank for the consumer's credit, charge or debit card. Alternatively, the financial institution may be the consumer's bank (e.g., for person-to-person (P2P) or person-to-business (P2B) payments). At 1095, the financial institution processes the authorization request and either approves or rejects it. The financial institution then transmits the response (approve/reject) back to the payment network as shown in FIG. 10B. At 1096, the response (approve/reject) is transmitted to the particular payment processor for the merchant of record. The payment processor for the merchant of record then relays the response (approve/reject) to the payment gateway, which at 1097 then transmits the response (approve/reject) back to the server 1010. The server 1010 confirms success or failure of the payment transaction at 1098. Optionally, the consumer is notified and/or the payment transaction is completed. It should be understood that the operations for facilitating mobile payment transactions as described with regard to FIG. 1013 are provided only as an example. This disclosure contemplates that the operations can include more, less, or different steps than those illustrated in FIG. 1013. For example, FIGS. 12-15 illustrate operations for facilitating mobile payment transactions according to other implementations described herein. FIGS. 12A-12C illustrates example operations for completing a mobile payment transaction with credit card information. FIGS. 13A-13D illustrates example operations for completing a mobile payment transaction with a network token. FIGS. 14A-14B and 15A-15B illustrate tokenized card payments between the user and multiple merchants.

Referring again to FIG. 10A, the location service 1008 allows content 1022 to optionally be transmitted to the user device 1062 based on a location of the user device 1062, e.g., by “geofencing” a merchant's location. This disclosure contemplates that geofencing can be handled by a partner app that hands off transactions to the location service 1008. Alternatively or additionally, the location service 1008 provides the partner app with locations based on the location of the user device 1062.

In some implementations, the microsite is configured to facilitate tokenized card payments between the user and multiple vendors. FIGS. 14A and 14B illustrate example operations for when the user pays for goods/services with a new card. FIGS. 15A and 15B illustrate example operations when the user pays for goods/services with a card on file. In both scenarios, the user's financial information (e.g., credit card number, bank account number, PAN, etc.) is tokenized. This is shown by reference number 1400 in FIG. 14A, where the user's credit card information (e.g., card type, number, expiration date, etc.) has been transmitted to a payment gateway via the microsite. The user's credit card information is tokenized for the microsite, and the token is transmitted from the payment gateway back to the microsite. The microsite accesses the token for use facilitating payment transactions on behalf of a plurality of vendors. This is different than conventional systems and methods, where a token is created and issued for use by a particular merchant (i.e., the merchant of record). In other words, a user's credit card information is conventionally tokenized for use with a specific merchant identifier such that the user's token is used to facilitate payment transactions only with the merchant of record. The same user's credit card information may be separately tokenized for use by other merchants of record. Thus, a token is not universal to multiple vendors using the same, or different, processors in conventional systems and methods. In contrast, the token created and issued as shown by reference number 1400 in FIG. 14A is used by the microsite to facilitate payment transactions on behalf of multiple vendors. The microsite is a conduit for transactions but the vendors remain merchants of record for their respective transactions. The token stored and submitted by the microsite is therefore universal to a plurality of vendors (i.e., one-to-many).

Step 1450 in FIGS. 14A and 15A illustrates token storage (e.g., in a token vault). Step 1452 in FIGS. 14A and 15A illustrates how the microsite initiates an authorization request, which includes the token and purchase information. Such authorization is initiated by the user, for example using a mobile app or API, for specific goods/services. The microsite uses the same token to facilitate payment transaction on behalf of first and second vendors, each of which is merchant of record for its respective transaction. As described herein, the first and second vendors may be unrelated, e.g., different types of vendors (e.g., a gas station and a restaurant) or different vendors of the same type (e.g., two different gas stations). In other words, the same token is universal for a plurality of vendors. In contrast to conventional systems and methods, a different token for each vendor is not needed. Instead, the microsite submits the same token on behalf of each vendor. For example, step 1454 in FIGS. 14A and 15A illustrates how the microsite creates the authorization request on behalf of a vendor. The microsite does this on behalf of multiple vendors, and the microsite submits the authorization request to the appropriate payment processor for a vendor via the payment gateway. It should be understood that the first and second vendors can have the same or different payment processors. The microsite manages this information such that the same token can be submitted on behalf of multiple vendors. Step 1456 in FIGS. 14A and 15A illustrates how the gateway de-tokenizes the token to obtain the user's credit card information such that the authorization request can be transmitted to the appropriate payment processor. Step 1458 in FIGS. 14A and 15A illustrates how the authorization request is provided to the appropriate payment network of a particular vendor. The payment network can validate or decline the authorization request and such information can be transmitted back to the microsite via the payment gateway.

In some implementations, the step of facilitating a mobile payment transaction includes receiving, at the microsite, authorization for the mobile payment transactions from the user's mobile computing device. In other implementations, authorization for the mobile payment transactions is received from the user's Internet-connected device such as a vehicle, television, or consumer appliance (e.g., refrigerator). It should be understood that authorization is received for each respective mobile payment transaction. Optionally, the method further includes encrypting at least a portion of the respective account profile associated with the user. This disclosure contemplates that encryption can be used before transmission from the microsite to the payment gateway and/or payment processor. This disclosure also contemplates using encryption techniques known in the art, which include, but are not limited to, hashing, transport security layer (TLS), or other encryption methods.

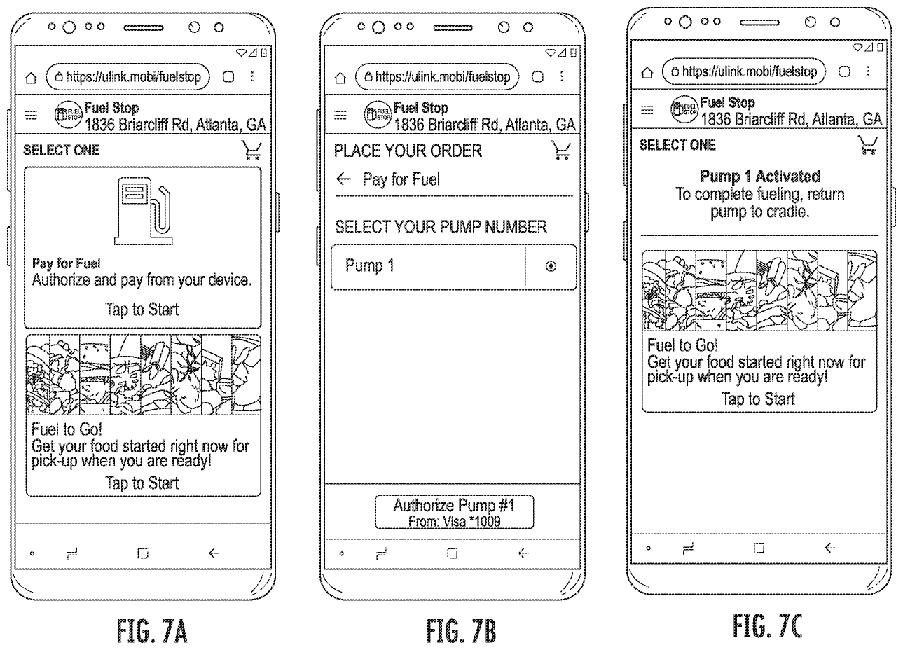

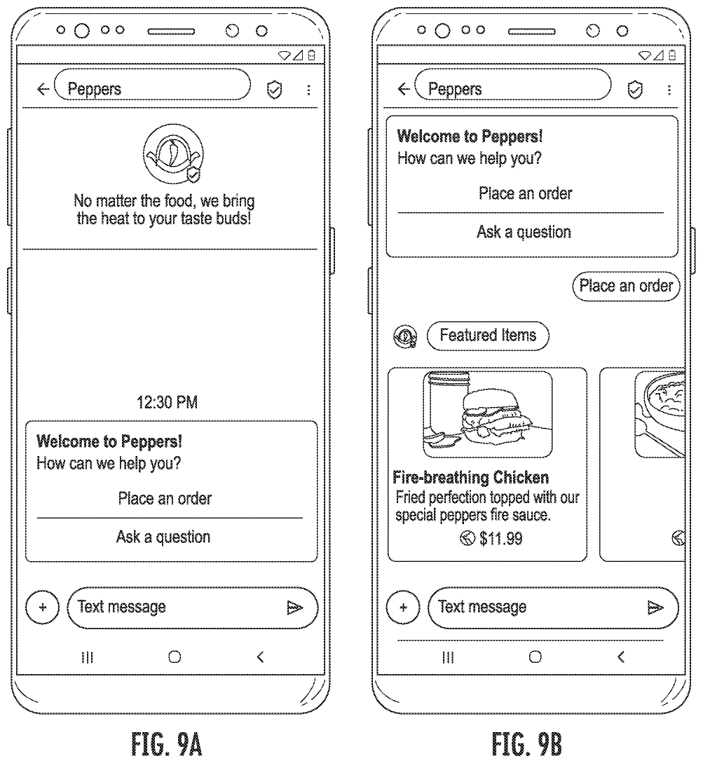

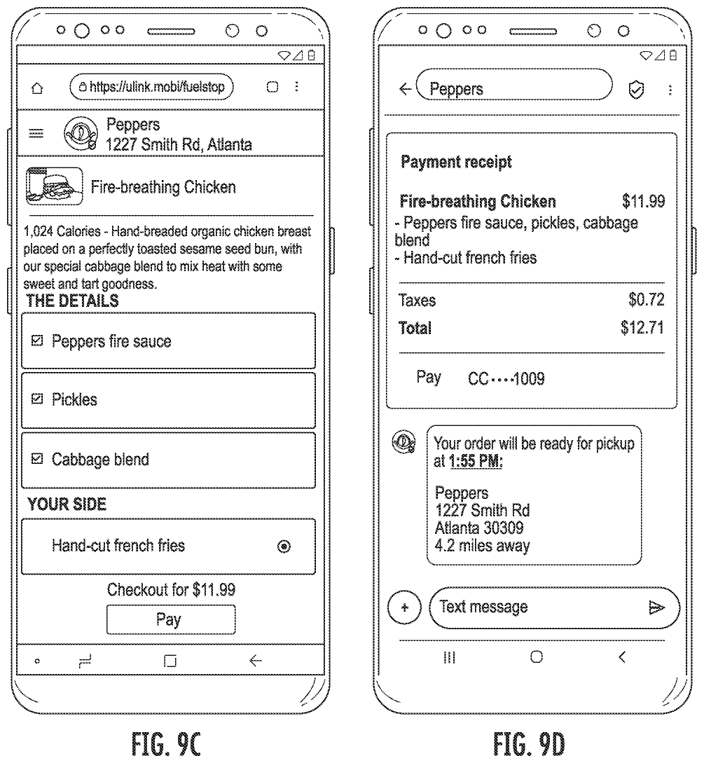

FIGS. 7A-7C illustrate an example process for completing a mobile payment transaction at a fuel/gas vendor. For example, in FIG. 7A, the user is presented with an offer by the vendor. This can be initiated, for example, by the user scanning a bar code, conducting an Internet search, using a mobile app, and/or based on the user's location. In FIG. 7B, the user has selected “Pay for Fuel” and is presented with an option to select a pump. In FIG. 7C, fueling is authorized and the user is presented with instructions for completing the transaction. As described herein, the mobile payment transaction is facilitated using the user's mobile device. FIGS. 9A-9D illustrate an example process for completing a mobile payment transaction with a restaurant vendor. In FIG. 9A, the user is presented with an offer by the vendor. This can be initiated, for example, by the user scanning a bar code, conducting an Internet search, using a mobile app, and/or based on the user's location. In FIG. 9B, the user is presented with menu options. In FIG. 9C, the user has selected menu items and is presented with instructions for completing the transaction. In FIG. 9D, the user is presented with confirmation of the purchase. As described herein, the mobile payment transaction is facilitated using the user's mobile device.

Optionally, the microsite (e.g., microsite 100 of FIG. 1) and/or the server (e.g., computing device 300 of FIG. 3) can register the user in a loyalty program associated with a vendor. As described herein, the user's account profile includes information about the user. One or more pieces of information contained in the user's account profile can be passed from the microsite and/or the server to the vendor's system. This enables the vendor associated with a transaction to update the user's loyalty balance as though the user had interacted directly with the merchant point of sale (POS) system or website. Additionally, the microsite can optionally facilitate a user to automatically opt-in to a loyalty program with a one-time approval. For example, when the user creates an account profile at the microsite during a transaction with a first vendor (e.g., restaurant), the microsite can auto-join the user and/or present the user with the option of joining the loyalty program of a second vendor (e.g., gas station). This may occur in response to the user crossing the geofence of the second vendor and completing a transaction in response.

It should be appreciated that the logical operations described herein with respect to the various figures may be implemented (1) as a sequence of computer implemented acts or program modules (i.e., software) running on a computing device (e.g., the computing device described in FIG. 3), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 3, an example computing device 300 upon which the methods described herein may be implemented is illustrated. It should be understood that the example computing device 300 is only one example of a suitable computing environment upon which the methods described herein may be implemented. Optionally, the computing device 300 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 300 typically includes at least one processing unit 306 and system memory 304. Depending on the exact configuration and type of computing device, system memory 304 may be volatile (such as random access memory (RAM)), non-volatile (such as read-only memory (ROM), flash memory, etc.), or some combination of the two. This most basic configuration is illustrated in FIG. 3 by dashed line 302. The processing unit 306 may be a standard programmable processor that performs arithmetic and logic operations necessary for operation of the computing device 300. The computing device 300 may also include a bus or other communication mechanism for communicating information among various components of the computing device 300.

Computing device 300 may have additional features/functionality. For example, computing device 300 may include additional storage such as removable storage 308 and non-removable storage 310 including, but not limited to, magnetic or optical disks or tapes. Computing device 300 may also contain network connection(s) 316 that allow the device to communicate with other devices. Computing device 300 may also have input device(s) 314 such as a keyboard, mouse, touch screen, etc. Output device(s) 312 such as a display, speakers, printer, etc. may also be included. The additional devices may be connected to the bus in order to facilitate communication of data among the components of the computing device 300. All these devices are well known in the art and need not be discussed at length here.

The processing unit 306 may be configured to execute program code encoded in tangible, computer-readable media. Tangible, computer-readable media refers to any media that is capable of providing data that causes the computing device 300 (i.e., a machine) to operate in a particular fashion. Various computer-readable media may be utilized to provide instructions to the processing unit 306 for execution. Example tangible, computer-readable media may include, but is not limited to, volatile media, non-volatile media, removable media and non-removable media implemented in any method or technology for storage of information such as computer readable instructions, data structures, program modules or other data. System memory 304, removable storage 308, and non-removable storage 310 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 306 may execute program code stored in the system memory 304. For example, the bus may carry data to the system memory 304, from which the processing unit 306 receives and executes instructions. The data received by the system memory 304 may optionally be stored on the removable storage 308 or the non-removable storage 310 before or after execution by the processing unit 306.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
maintaining, using a server, consumer information, wherein the consumer information comprises a plurality of respective account profiles associated with a plurality of consumers;
transmitting, using the server, vendor content associated with a first vendor to a user's mobile computing device;
transmitting, using the server, vendor content associated with a second vendor to the user's mobile computing device; and
facilitating, using the server, a plurality of mobile payment transactions with the user on behalf of the first and second vendors using a respective account profile associated with the user.

2. The computer-implemented method of claim 1, wherein the step of facilitating, using the server, the mobile payment transactions comprises facilitating a first mobile payment transaction with the user on behalf of die first vendor using the respective account profile associated with the user and facilitating a second mobile payment transaction with the user on behalf of the second vendor using the respective account profile associated with the user.

3. The computer-implemented method of claim 2, wherein the first and second mobile payment transactions am separate transactions.

4. The computer-implemented method of claim 2, wherein the first vendor is the merchant of record for the first mobile payment transaction and the second vendor is the merchant of record for the second mobile payment transaction.

5. The computer-implemented method of claim 2, wherein the step of facilitating, using the server, the mobile payment transactions comprises causing information from the respective account profile associated with the user to be transmitted to a respective payment processor associated with each of the first and second vendors.

6. (canceled)

7. The computer-implemented method of claim 5, wherein the information from the respective account profile associated with the user comprises a token.

8. The computer-implemented method claim 5, wherein the information from the respective account profile associated with the user comprises a payment account number or an electronic money transfer request.

9. The computer-implemented method of claim 5, further comprising encrypting, using the server, the information from the respective account profile associated with the user.

10. The computer-implemented method of claim 5, wherein the step of facilitating, using the server, the mobile payment transactions further comprises receiving, at the server, a respective validation from the respective payment processors associated with the first and second vendors.

11. The computer-implemented method of claim 1, wherein the vendor content is transmitted to the user's mobile computing device based on a location of the user's mobile computing device.

12. The computer-implemented method of claim 1, wherein the vendor content is transmitted in a text message, instant message, or rich communication services message.

13. The computer-implemented method of claim 1, wherein the vendor content comprises a menu or an offer for a good or service.

14. (canceled)

15. The computer-implemented method of claim 1, wherein the vendor content is configured for display on the user's mobile computing device.

16. The computer-implemented method of claim 15, wherein the vendor content is tailored to a vendor's business processes or requirements.

17. The computer-implemented method of claim 1, further comprising maintaining or accessing, using the server, vendor information associated with a plurality of vendors.

18. The computer-implemented method of claim 17, wherein the vendors comprise a fuel retailer, an electric vehicle charging company, a convenience store, a grocery store, a restaurant, a parking company, a hotel or motel, or combinations thereof.

19. The computer-implemented method claim 1, wherein each of the account profiles comprises personal information, financial information, and payment method information.

20. The computer-implemented method of claim 1, wherein each of the account profiles comprises a token.

21. The computer-implemented method of claim 1, further comprising tokenizing at least a portion of each of the account profiles.

22. The computer-implemented method of claim 1, wherein the step of facilitating, using the server, the mobile payment transactions further comprises receiving, at the server, authorization for the mobile payment transactions from the user's mobile computing device.

23. The computer-implemented method of claim 22, wherein the authorization for the mobile payment transactions is received from the user's mobile computing device via a microsite hosted by the server.

24. The computer-implemented method of claim 1, further comprising registering, using the server, a user in a loyalty program associated with a vendor.

25. A computer-implemented method, comprising:
maintaining, using a server, consumer information, wherein the consumer information comprises a plurality of respective account profiles associated with a plurality of consumers;
transmitting, using the server, vendor content associated with a first vendor to a user's Internet-connected device;
transmitting, using the server, vendor content associated with a second vendor to the user's internet-connected device; and
facilitating, using the server, a plurality of mobile payment transactions with the user on behalf of the first and second vendors using a respective account profile associated with the user.

26. The computer-implemented method of claim 25, wherein the user's Internet-connected device is a television, a vehicle, or an appliance.

27-49. (canceled)

50. A system, comprising:
a server comprising a processor and a memory in operable communication with the processor, the memory having computer-executable instructions stored thereon that, when executed by the processor, cause the processor to:
maintain consumer information, wherein the consumer information comprises a plurality of respective account profiles associated with a plurality of consumers;
transmit vendor content associated with a first vendor to a user's device;
transmit vendor content associated with a second vendor to the user's device; and
facilitate a plurality of mobile payment transactions with the user on behalf of the first and second vendors using a respective account profile associated with the user.

51. (canceled)

52. The system of claim 50, wherein the user's device is a mobile computing device.

53. (canceled)

54. The system of claim 50, wherein the user's device is an internet-connected device.

55. The system of claim 54, wherein the Internet-connected device is a television, a vehicle, or an appliance.

56-78. (canceled)

79. The computer-implemented method of claim 5, wherein the information from the respective account profile associated with the user comprises a bank account number.

80. The computer-implemented method of claim 79, wherein each of the plurality of mobile payment transactions with the user is facilitated in real-time.
